(19) United States
(12) Patent Application Publication
(10) Pub. No.: US 2007/0230378 A1
(43) Pub. Date: Oct. 4, 2007

(54) Traffic prediction in wireless communication networks

(76) Inventors: Clifford Tavares, San Carlos, CA (US); Todor Cooklev, Moraga, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/394,494

(22) Filed: Mar. 31, 2006

(51) Int. Cl. H04B 7/00

(52) U.S. Cl. 370/310

(57) ABSTRACT

A method in a first station comprises monitoring a network allocation vector in a wireless network; using the network allocation vector to predict an access pattern, e.g., periodic access for a given duration, by a second station in the wireless network; and performing a response based on the predicted access pattern. The response may include modifying a MAC layer parameter, e.g., TXOP or a prediction backoff value, and/or a physical layer parameter, in the first station based on the predicted access pattern. The response may include informing a neighboring network of the predicted access pattern, causing the first station to enter a power-saving mode during times based on the predicted access pattern of the second station, or determining whether to connect the first station into the wireless network. The first station and/or second station may include a client station or an access point.

### TECHNICAL FIELD

This invention relates generally to wireless networks, and more particularly provides a traffic prediction mechanism in wireless communication networks.

### BACKGROUND

As users experience the convenience of wireless connectivity, they are demanding increasing support. Typical applications over wireless networks address include video streaming, video conferencing, distance learning, etc. Because wireless bandwidth availability is restricted, quality of service (QoS) management is increasingly important in 802.11 networks. IEEE 802.11e proposes to define QoS mechanisms for wireless gear that gives support to bandwidth-sensitive applications such as voice and video.

The original 802.11 media access control (MAC) protocol was designed with two modes of communication for wireless stations. The first mode, Distributed Coordination Function (DCF), is based on Carrier Sense Multiple Access with Collision Avoidance (CSMA/CA), sometimes referred to as “listen before talk.” A station waits for a quiet period on the network and then begins to transmit data and detect collisions. The second mode, Point Coordination Function (PCF), supports time-sensitive traffic flows. Wireless access points periodically send beacon frames to communicate network identification and management parameters specific to the wireless network. Between sending beacon frames, PCF splits the time into a contention-free period and a contention period. A station using PCF transmits data during contention-free periods.

Because DCF and PCF do not differentiate between traffic types or sources, IEEE proposed enhancements to both coordination modes to-facilitate QoS. These changes are intended to fulfill critical service requirements while maintaining backward-compatibility with current 802.11 standards.

Enhanced Distribution Coordination Access (EDCA) introduces the concept of traffic categories. Using EDCA, stations try to send data after detecting that the medium is idle for a set time period defined by the corresponding traffic category. A higher-priority traffic category will have a shorter wait time than a lower-priority traffic category. While no guarantees of service are provided, EDCA establishes a probabilistic priority mechanism to allocate bandwidth based on traffic categories.

The IEEE 802.11e EDCA standard provides. QoS differentiation by grouping traffic into four access classes (ACs), i.e. voice, video, best effort and background. The voice AC has the highest priority; the video AC has the second highest priority; the best effort AC has the third highest priority; and the background AC has the lowest priority. Each AC has its own transmission queue and its own set of medium access parameters. Traffic prioritization uses the medium access parameters—AIFS interval, contention window (CW), and transfer opportunity (TXOP)—defined on a per-class basis, to ensure that higher priority AC has relatively more medium access opportunity than a lower priority AC.

Generally, the Arbitration Interframe Space (AIFS) is the time interval that a station must sense the medium to be idle before invoking a backoff or transmission. A higher priority AC uses a smaller AIFS interval. The Contention Window (CW, CWmin and CWmax) indicates the number of backoff time slots until the station can access the medium. CW is randomly drawn from the range [1, CW-1] in a uniform manner. CW starts from CWmin and doubles every time a transmission fails until it reaches its maximum value CWmax. Then, CW holds its maximum value until the transmission exceeds its retry limit. A higher priority AC uses smaller CWmin and CWmax. The Transmission Opportunity (TXOP) indicates the maximum duration that an AC can be allowed to transmit frames after acquiring access to the medium.

To reduce the probability of two stations colliding, because the two stations cannot hear each other, the standard defines a virtual carrier sense mechanism. Before a station initiates a transaction, the station first transmits a short control packet called RTS (Request To Send), which includes the source address, the destination address and the duration of the upcoming transaction (i.e. the data packet and the respective ACK). Then, the destination station responds (if the medium is free) with a response control packet called CTS (Clear to Send), which includes the same duration information. All stations receiving either the RTS and/or the CTS set a virtual carrier sense indicator, i.e., the network allocation vector (NAV), for the given duration, and use the NAV together with the physical carrier sense when sensing the medium. This mechanism reduces the probability of a collision in the receiver area by a station that is “hidden” from the transmitter station to the short duration of the RTS transmission, because the station hears the CTS and “reserves” the medium as busy until the end of the transaction. The duration information in the RTS also protects the transmitter area from collisions during the ACK from stations that are out of range of the acknowledging station. Due to the fact that the RTS and CTS are short frames, the mechanism reduces the overhead of collisions, since these frames are recognized more quickly than if the whole data packet was to be transmitted (assuming the data packet is bigger than RTS). Accordingly, the standard allows for short data packets to be transmitted without the RTS/CTS transaction. This is controlled per station by a parameter called RTS Threshold.

With these medium access parameters (including AIFS, CW, TXOP and NAV), EDCA works in the following manner: Before a transmitting station can initiate any transmission, the transmitting station must first sense the channel idle (physically and virtually) for at least an AIFS time interval. If the channel is idle after the AIFS interval, the transmitting station invokes a backoff procedure using a backoff counter to count down a random number of backoff time slots. The transmitting station decrements the backoff counter by one as long as the channel is sensed to be idle. Once the backoff counter reaches zero, the transmitting station initiates an RTS transmission and awaits a CTS transmission from the receiving station. If the transmitting station receives a CTS transmission from the receiving station, the transmitting station initiates the transaction. The station can initiate multiple frame transmissions without additional contention as long as the total transmission time does not exceed the TXOP duration.

If the transmitting station senses the channel to be busy at any time during the backoff procedure, the transmitting station suspends its current backoff procedure and freezes its backoff counter until the channel is sensed to be idle for an AIFS interval again. Then, if the channel is still idle after the AIFS interval, the transmitting station resumes decrementing its remaining backoff counter. After each unsuccessful transmission, the contention window doubles until CWmax. After a successful transmission, the contention window returns to CWmin. The level of QoS control for each AC is determined by the combination of the medium access parameters and the number of competing stations in the network.

FIG. 1 is a timing diagram 100 illustrating virtual carrier sense timing for a transmitting station 105, receiving station 110 and other stations 115. As shown, after a arbitrary interframe space (AIFS) 120, the transmitting station 105 initiates a request-to-send (RTS) transmission 125 to the receiving station 110. The RTS transmission 125 includes the transmitter address, the receiver address, and a duration for the transaction. Upon receiving the RTS transmission 125 and after a short interframe space (SIFS) 130, the receiving station 110 initiates a clear-to-send (CTS) transmission 135 to the transmitting station 105. Upon receiving the CTS transmission and after an SIFS 140, the transmitting station 105 initiates data transmission 145 to the receiving station 110. Upon completion of the data transmission 145 and after an SIFS 150, the receiving station 110 initiates ACK transmission 155 to the transmitting station 105. Other stations 115 monitor the wireless network for RTS and/or CTS transmissions, e.g., RTS transmission 125 and/or CTS transmission 135. Upon noting the RTS and/or CTS transmission, the other stations 115 set their network allocation vector (NAV) 160 to count down the duration of the transaction through the ACK transmission 155. That way, other stations 115 can avoid unnecessary wireless network monitoring.

Although the EDCA methods have improved multimedia transmissions over WLANs, the QoS requirements (delay, jitter, bandwidth and bit error rate, etc.) of multimedia transmissions are still not being met. Accordingly, a system and method for improving QoS for multimedia transmissions in wireless local area networks (WLANs) are needed.

### SUMMARY

A traffic predictor includes a network allocation vector (NAV) monitor, a traffic prediction module, and a response engine. The traffic predictor may be integrated into a station, e.g., into a client station or into an access point. The NAV monitor monitors the NAV in the MAC layer (e.g., monitors RTS and/or CTS). By monitoring the NAV in the MAC layer, the NAV monitor can monitor wireless medium access behavior of neighboring stations on a station-by-station basis. The NAV monitor can capture the station identification information and the duration information from the NAV and can forward the information to the traffic prediction module. The traffic prediction module can use the station identification information and the duration information to determine the anticipated needs of neighboring stations (e.g., periodicity and duration). The response engine responds to the prediction information. If the traffic predictor is integrated into an access point, then the response engine may determine whether there is sufficient bandwidth to allow another station to enter the wireless network given the predicted needs of stations already in the network. If the traffic predictor is integrated into a client station, then the response engine may recommend that the client station select another network if little bandwidth is available, may inform the access point, may perform a backoff mechanism in accordance with the predicted needs of the other stations, may enter a power saving mode in accordance with the predicted needs of the other stations, may inform applications of the predicted use of the wireless medium, may conduct analyses to determine best available communication modes, etc.

In one embodiment, the present invention provides a method in a first station comprising monitoring a network allocation vector in a wireless network; using the network allocation vector to predict an access pattern, e.g., periodic access for a given duration, by a second station in the wireless network; and performing a response based on the predicted access pattern. The response may include modifying a MAC layer parameter, e.g., TXOP or a prediction backoff value, and/or a physical layer parameter, in the first station based on the predicted access pattern. The response may include informing a neighboring network of the predicted access pattern, causing the first station to enter a power-saving mode during times based on the predicted access pattern of the second station, or determining whether to connect the first station into the wireless network. The first station and/or second station may include a client station or an access point.

In another embodiment, the present invention provides a system in a first station comprising a network allocation vector monitor for monitoring a network allocation vector in a wireless network; a traffic prediction module for using the network allocation vector to predict access pattern, e.g., periodic access for a given duration, by a second station in the wireless network; and a response engine for performing a response based on the predicted access pattern. The response engine may include a MAC layer parameter adjustment module for modifying a MAC layer parameter, e.g., TXOP or a prediction backoff value, and/or a physical layer parameter, in the first station based on the predicted access pattern. The response may include informing a neighboring network of the predicted access pattern, causing the first station to enter a power-saving mode during times based on the predicted access pattern of the second station, and/or determining whether to connect the first station into the wireless network. The first station and/or second station may include a client station or an access point.

In another embodiment, the present invention provides a system in a first station comprising means for monitoring a network allocation vector in a wireless network; means for using the network allocation vector to predict an access pattern by a second station in the wireless network; and means for performing a response based on the predicted access pattern.

### BRIEF DESCRIPTION OF THE DRAWINGS

FIG. 1 is a block diagram illustrating a timing diagram of a virtual sense mechanism in an IEEE 802.11e wireless network.

FIG. 2 is a block diagram illustrating a traffic predictor, in accordance with an embodiment of the present invention.

FIG. 3 is a block diagram illustrating a station with a traffic predictor, in accordance with a first embodiment of the present invention.

FIG. 4 is a block diagram illustrating a station with a traffic predictor, in accordance with a second embodiment of the present invention.

FIG. 5 is a block diagram illustrating a prediction scheduler of FIG. 4, in accordance with an embodiment of the present invention.

FIG. 6 is a block diagram illustrating details of a computer system.

FIG. 7 is a flowchart illustrating a method of predicting and responding to traffic patterns, in accordance with an embodiment of the present invention.

FIG. 8 is a flowchart illustrating a method of predicting and responding to traffic patterns by a station, in accordance with an embodiment of the present invention.

FIG. 9 is a flowchart illustrating a method of predicting and responding to traffic patterns by an access point, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

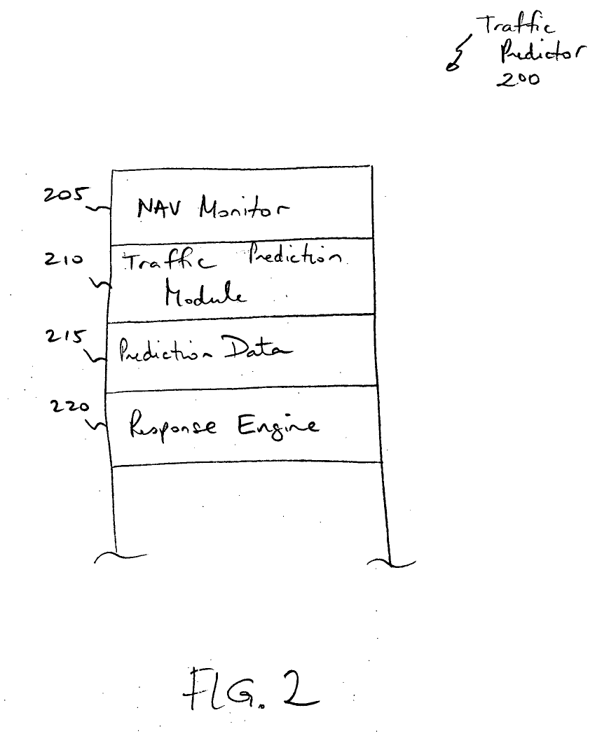

FIG. 2 is a block diagram illustrating a traffic predictor 200, in accordance with an embodiment of the present invention. Traffic predictor 200 includes a network allocation vector (NAV) monitor 205, a traffic prediction module 210, prediction data 215, and a response engine 220. The traffic predictor 200 may be integrated into a station, e.g., into a client station or into an access point.

The NAV monitor 205 monitors the NAV in the MAC layer (e.g., monitors RTS and/or CTS). By monitoring the NAV in the MAC layer, the NAV monitor 205 can monitor wireless medium access behavior of neighboring stations on a station-by-station basis. The NAV monitor 205 can capture the station identification information and the duration information from the NAV and can forward the information to the traffic prediction module 210.

The traffic prediction module 210 can use the station identification information and the duration information to generate prediction data 215, including the anticipated needs of neighboring stations (e.g., periodicity and duration). For example, two other stations may be using wireless medium access. The traffic prediction module 210 may determine that the first other station requires random access and that the second other station requires periodic access to the wireless medium. From this information, the traffic prediction module 210 can predict that the second other station will continue to require periodic access to the wireless medium, for example, because the second other station is receiving multimedia content that requires a particular quality of service. The prediction data 215 may include the predicted timing of the periodic access pattern and the duration of each access.

The response engine 220 responds to the prediction information. If the traffic predictor 200 is integrated into an access point, then the response engine 220 may determine whether there is sufficient bandwidth to allow another station to enter the wireless network given the predicted needs of stations already in the network. If the traffic predictor 200 is integrated into a client station, then the response engine 220 may recommend that the client station select another network if little bandwidth is available, may inform the access point, may perform a backoff mechanism in accordance with the predicted needs of the other stations, may enter a power saving mode in accordance with the predicted needs of the other stations, may inform applications of the predicted use of the wireless medium, may conduct analyses to determine best available communication modes, may select another channel over which to transmit a signal, may modify the occupied bandwidth over which to send the signal, etc.

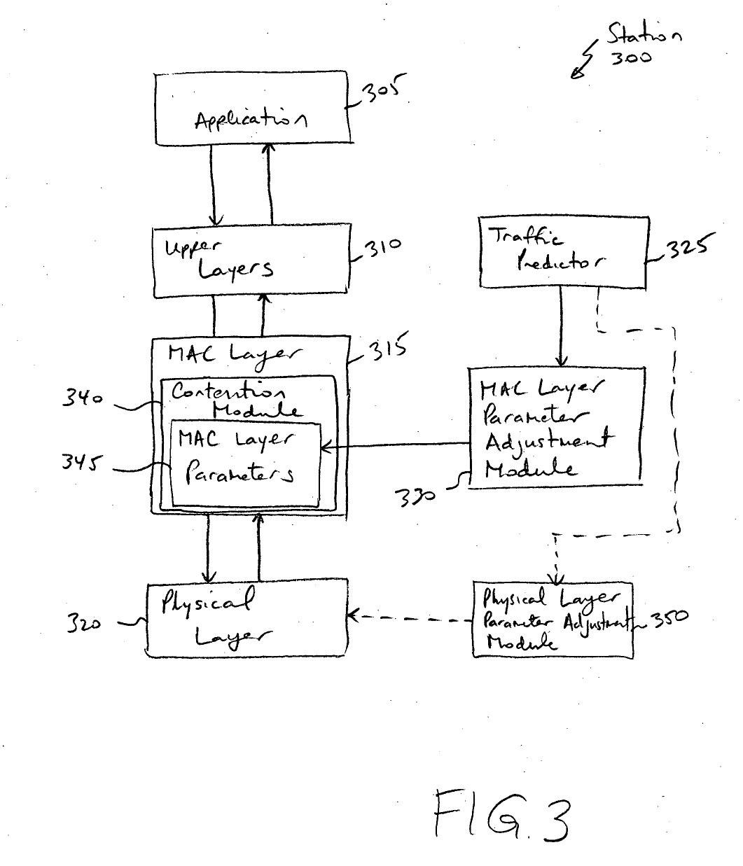

FIG. 3 is a block diagram illustrating a station 300 with a traffic predictor 325, in accordance with a first embodiment of the present invention. The traffic predictor 200 of FIG. 2 may be an embodiment of the traffic predictor 325. Station 300 includes an application 305 in the application layer, upper layers 310 (which can include the application layer), a MAC layer 315, and a physical layer 320.

The application 305 generates wireless medium traffic needs. When acting as a source of information, the application 305 forwards data down though the upper layers 310 to the MAC layer 315, which includes a contention module 335 that performs the contention-based procedures using MAC layer parameters 345 (such as conventional EDCA parameters including AIFS, CW, TXOP and NAV) before enabling data transmission. After a successful contention, the MAC layer 315 transmits the data to the physical layer 320, which transmits the data to the wireless medium. When acting as a receiver, the application 305 receives wireless network traffic data for execution, playback, presentation, etc. The application 305 may include a browser, a multimedia player, etc.

In this embodiment, the traffic predictor 325 resides in the upper layers 310 and monitors the network allocation vector (NAV) for predictable access patterns (e.g., periodic access) by other stations. By recognizing the predictable access patterns, the traffic predictor 325 may predict that specific other stations will continue to require access to the wireless medium in accordance with those patterns. The traffic predictor 325 may generate traffic pattern data that indicates the traffic pattern needed by each station (e.g., the periodic pattern between transmissions). Based on this traffic pattern data, the traffic predictor 325 may dynamically predict wireless medium availability and/or unavailability, which it may use to dynamically generate MAC layer parameter adjustment values and/or physical layer parameter values.

In this embodiment, the station 300 includes a MAC layer parameter adjustment module 330 that receives the MAC layer parameter adjustment values from the traffic predictor 325, and uses the values to adjust one or more parameters in the MAC layer 315. For example, the MAC layer parameter adjustment module 330 may adjust TXOP to reduce the duration of transmissions on the wireless network by station 300, thereby increasing available bandwidth for the other stations requiring access.

The station 300 may also include a physical layer parameter adjustment module 350 that receives physical layer parameter adjustment values from the traffic predictor 325, and uses the values to adjust one or more parameters in the physical layer 315. For example, the physical layer adjustment module 350 may select different channels over which to send signals or may adjust the occupied bandwidth of signals (e.g., from 40 MHz to 20 MHz or from 20 MHz to 40 MHz).

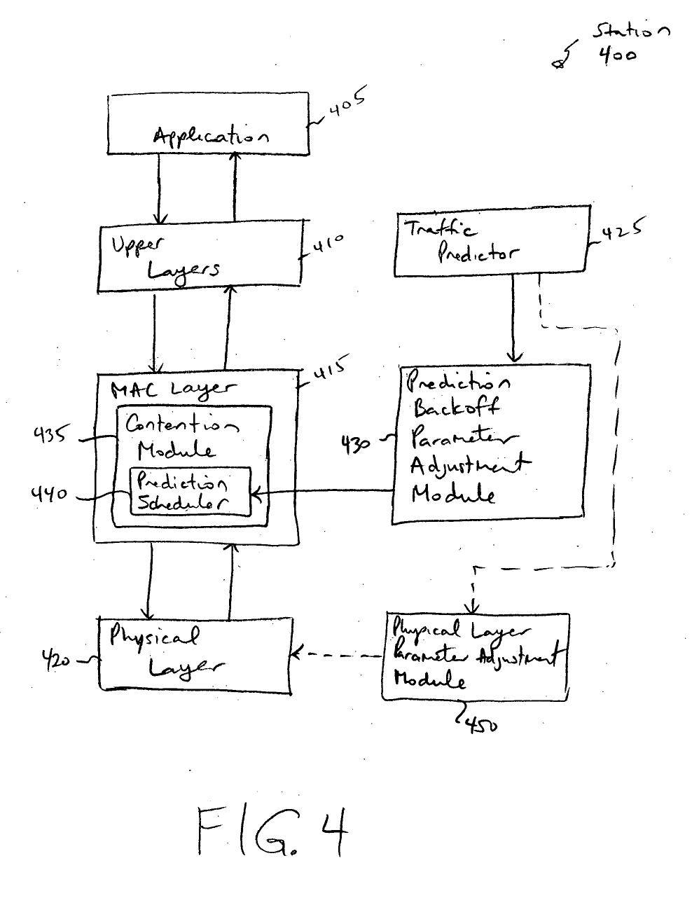

FIG. 4 is a block diagram illustrating a station 400 with a traffic predictor 425, in accordance with a second embodiment of the present invention. The traffic predictor 200 of FIG. 2 may be an embodiment of the traffic predictor 425. Station 400 includes an application 405 in the application layer, upper layers 410 (which can include the application layer), a MAC layer 415, and a physical layer 420.

The application 405 generates wireless medium traffic needs. When acting as a source of information, the application 405 forwards data down though the upper layers 410 to the MAC layer 415, which performs contention-based procedures before enabling data transmission. After a successful contention, the MAC layer 415 transmits the data to the physical layer 420, which transmits the data to the wireless medium. When acting as a receiver, the application 405 receives wireless network traffic data for execution, playback, presentation, etc. The application 405 may include a browser, a multimedia player, etc.

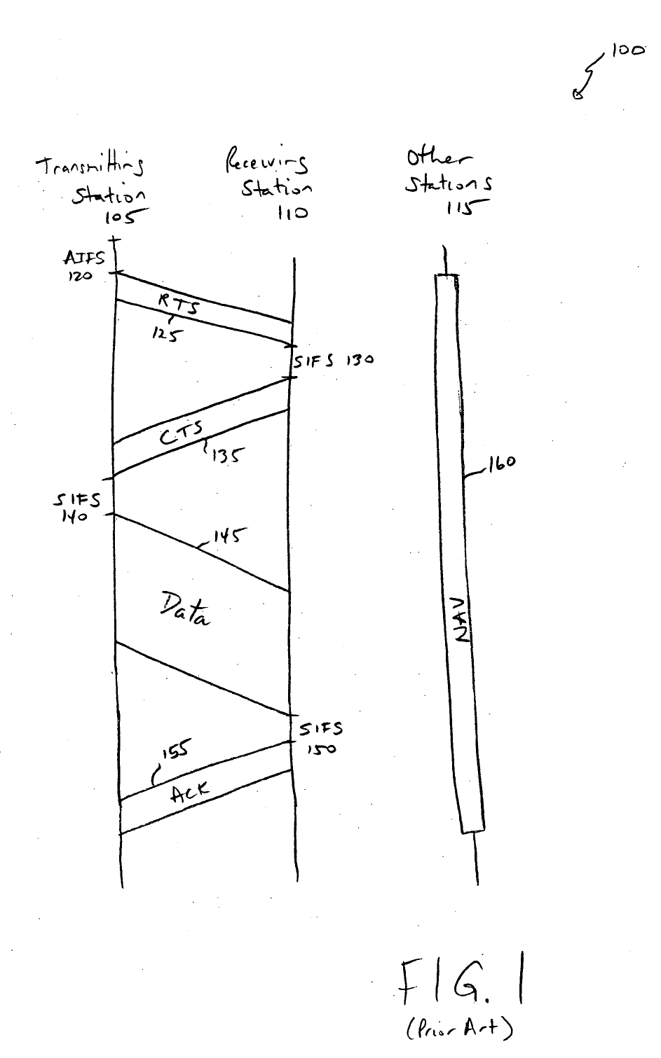

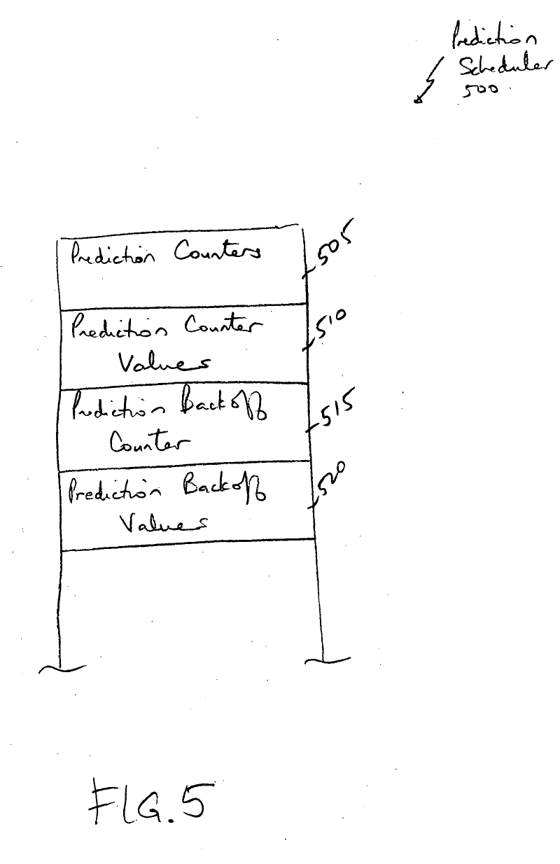

The MAC layer 415 includes a contention module 435 that performs contention-based procedures, such as AIFS, CW, TXOP, NAV and other conventional EDCA procedures. In this embodiment, the contention module 435 further includes a prediction scheduler 440 that performs a prediction backoff algorithm in addition to the other contention-based procedures to account for predicted traffic from other stations (e.g., station 105 of FIG. 1) on the wireless network. An embodiment of the prediction scheduler 440 is described in FIG. 5.

As shown in this embodiment, the traffic predictor 425 resides in the upper layers 410 and monitors the network allocation vector (NAV) for predictable access patterns (e.g., periodic access) by other stations. By recognizing the predictable access patterns, the traffic predictor 425 may predict that the other stations will continue to require access to the wireless medium in accordance with those patterns. The traffic predictor 425 may generate traffic pattern data that indicates the traffic pattern needed by each station (e.g., the periodic pattern between transmissions). Based on this traffic pattern data, the traffic predictor 425 may dynamically predict wireless medium availability and/or unavailability, which it may use to dynamically generate MAC layer prediction backoff parameter adjustment values (and/or possibly physical layer parameter values).

The station 400 also includes a MAC layer prediction backoff parameter adjustment module 430 that receives the MAC layer prediction backoff parameter adjustment values from the traffic predictor 425, and uses the data to adjust a prediction backoff parameters in the MAC layer 415.

The station may also include a physical layer parameter adjustment module 450 that receives physical layer parameter adjustment values from the traffic predictor 425, and uses the values to adjust one or more parameters in the physical layer 415. For example, the physical layer adjustment module 450 may select different channels over which to send signals or may adjust the occupied bandwidth of signals.

FIG. 5 is a block diagram illustrating a prediction scheduler 500, e.g., prediction scheduler 440 of FIG. 4, in accordance with an embodiment of the present invention. Prediction scheduler 500 includes prediction counters 505, prediction counter values 510, prediction backoff counter 515, and prediction backoff values 520.

The prediction counter 505 uses the prediction counter values 510 to synchronize its associated station with predicted access patterns of other stations. For example, a first station requests access to the wireless medium every 100 counts for 15 counts and a second station requests access every 75 counts for 10 counts, offset from the first station's use by 50 counts. In response, a first prediction counter value 510 can be set to cause a first prediction counter 505 to predict access by the first station every 100 counts. A second prediction counter value 510 can be set to cause a second prediction counter 505 to predict access by the second station every 75 counts, offset from the first station by 50 counts. One prediction counter 505 may be needed per station predicted to access the wireless medium according to a predictable pattern.

The prediction backoff counter 515 is intended to cause its associated station to backoff during the other station's predicted access period. Following the example above, the first station is predicted to access the wireless medium every 100 counts for 15 counts, and the second station is predicted to access the wireless medium every 75 counts for 10 counts, offset by 50 counts. The prediction backoff counter 515 and prediction backoff values 520 are set to count down 15 counts upon completion of the first prediction counter 505 and to count down 10 counts upon completion of the second prediction counter 505. During each predicted backoff period, the associated station may be configured to enter power saving mode (e.g., to avoid needlessly sensing the wireless medium) and not to initiate any transactions (or not to initiate any transactions of a predetermined traffic class, e.g., best effort and/or background). Upon completion of a predicted backoff period, the prediction counter 505 that initiated the predicted backoff period may be reset to begin its countdown again.

In another embodiment, the prediction counter values 50 may be reduced by and the prediction backoff values may be raised by a number of counts equal to an average duration for a transaction by the associated station. That way, a station does not initiate a transaction that it cannot complete before or approximately before a predicted access.

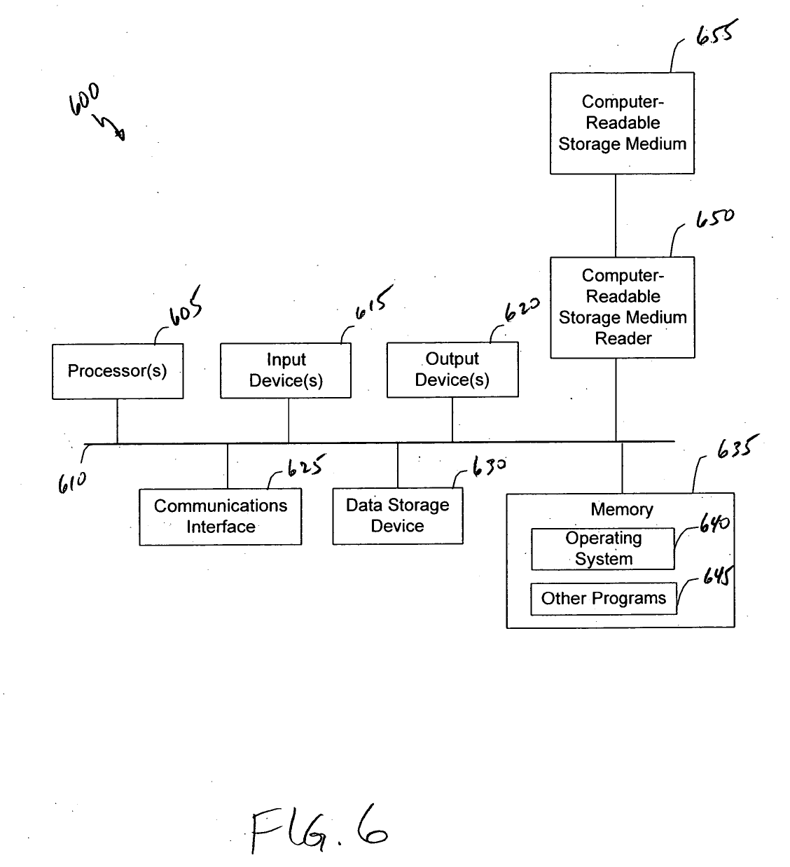

FIG. 6 is a block diagram illustrating details of a computer system 600, of which traffic predictor 200, station 300 or station 400 may be an instance. Computer system 600 includes a processor 605, such as an Intel Pentium® microprocessor or a Motorola Power PC® microprocessor, coupled to a communications channel 610. The computer system 600 further includes an input device 615 such as a keyboard or mouse, an output device 620 such as a cathode ray tube display, a communications device 625, a data storage device 630 such as a magnetic disk, and memory 635 such as Random-Access Memory (RAM), each coupled to the communications channel 610. The communications interface 625 may be coupled to a network such as the wide-area network commonly referred to as the Internet. One skilled in the art will recognize that, although the data storage device 630 and memory 635 are illustrated as different units, the data storage device 630 and memory 635 can be parts of the same unit, distributed units, virtual memory, etc.

The data storage device 630 and/or memory 635 may store an operating system 640 such as the Microsoft Windows NT or Windows/95 Operating System (OS), the IBM OS/2 operating system, the MAC OS, or UNIX operating system and/or other programs 645. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 600 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 650 such as a magnetic disk drive, hard disk drive, magneto-optical reader, CPU, etc. may be coupled to the communications bus 610 for reading a computer-readable storage medium (CRSM) 655 such as a magnetic disk, a hard disk, a magneto-optical disk, RAM, etc. Accordingly, the computer system 600 may receive programs and/or data via the CRSM reader 650. Further, it will be appreciated that the term “memory” herein is intended to cover all data storage media whether permanent or temporary.

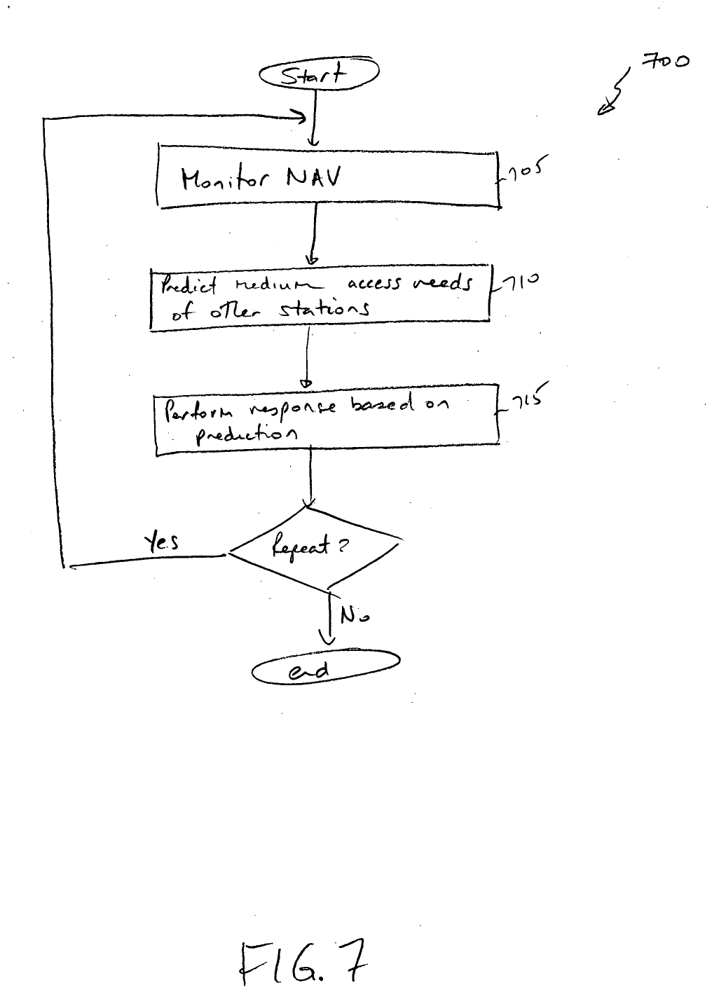

FIG. 7 is a flowchart illustrating a method 700 of predicting and responding to traffic patterns, in accordance with an embodiment of the present invention. Method 700 begins with the NAV monitor 205 in step 705 monitoring the network allocation vector (NAV), which includes monitoring the address information and the duration information. The traffic prediction module 210 in step 710 predicts the medium access needs of other stations in the hotspot, e.g., needs for transmitting and/or downloading video traffic. The traffic prediction module 210 in step 710 reviews the NAV for patterned access, e.g., periodic access of other stations, and predicts that the pattern will continue for future accesses. The response engine 220 in step 715 will respond based on the predicted pattern. For example, the response engine 220 may request modification of parameters (e.g., TXOP or a prediction backoff parameter) in the MAC layer, may inform other stations, may inform the access point, may inform other networks for improved roaming, may modify parameters in the physical layer, etc. Method 700 then determines whether to repeat, e.g., by determining whether the station is continuing its use of the wireless medium. If so, then the method 700 returns to step 705 to monitor the NAV. Otherwise, method 700 ends.

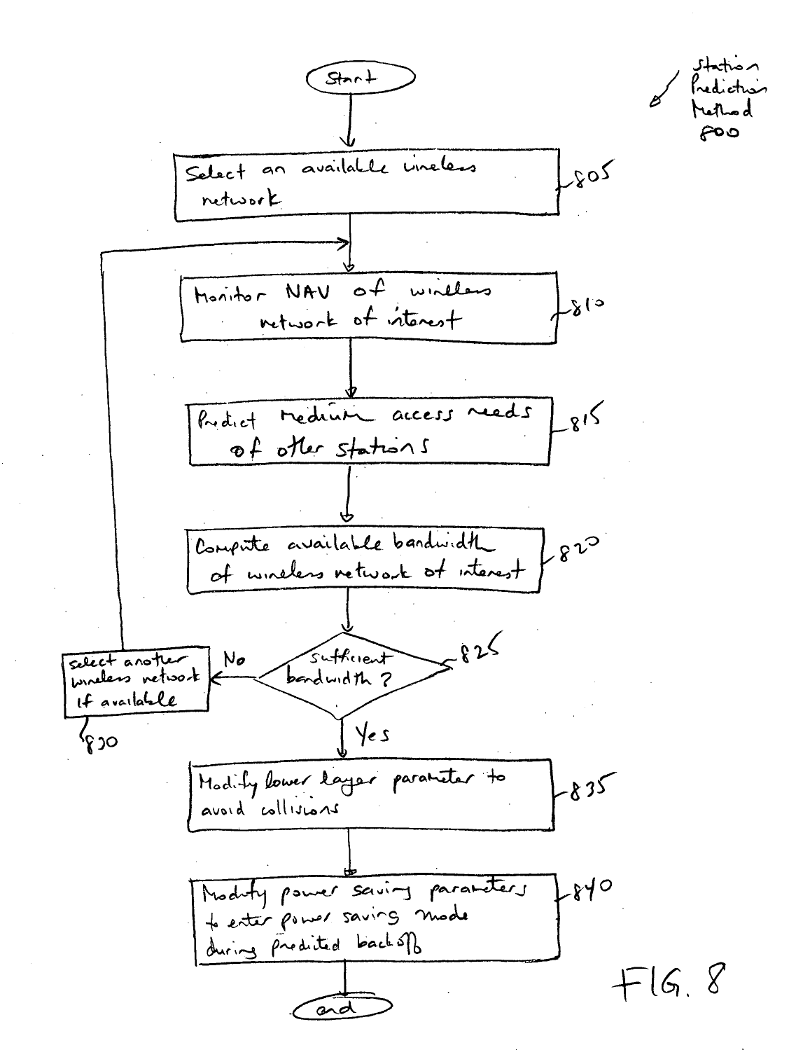

FIG. 8 is a flowchart illustrating a method 800 of predicting and responding to traffic patterns by a station, in accordance with an embodiment of the present invention. Method 800 begins with the station 300/400 in step 805 selecting an available wireless network. The NAV monitor 205 in step 810 monitors the NAV of the wireless network of interest. The traffic prediction module 210 in step 815 predicts the wireless medium access needs of other stations on the network, and in step 820 computes available bandwidth of the wireless network of interest assuming continuing use based on predictions.

The response engine 230 in step 825 determines if there is sufficient bandwidth for this station to enter the network. If not, then the response engine 230 in step 830 instructs the station to select another wireless network, if available. Then, method 800 returns to step 810 to begin monitoring the NAV of the newly selected network. If the response engine 230 determines that there is sufficient bandwidth, then the response engine 230 in step 835 modifies a lower layer parameter (e.g., a MAC layer or physical layer parameter) to avoid collisions based on the predicted-pattern of access by the other stations. In one example, the response engine 230 may include a MAC layer parameter adjustment module 330 that modifies a MAC layer parameter, e.g., TXOP, in the MAC layer 315. In another example, the response engine 230 may include a prediction backoff parameter adjustment module 430 that modifies one or more prediction backoff values in a prediction scheduler 440 in the MAC layer 415. In yet another embodiment, the response engine 230 may include a physical layer parameter adjustment module 350 that modifies one or more physical layer parameters in the physical layer 320. The response engine 230 in step 840 modifies power saving parameters to enter a power saving mode during a predicted backoff. Method 800 then ends.

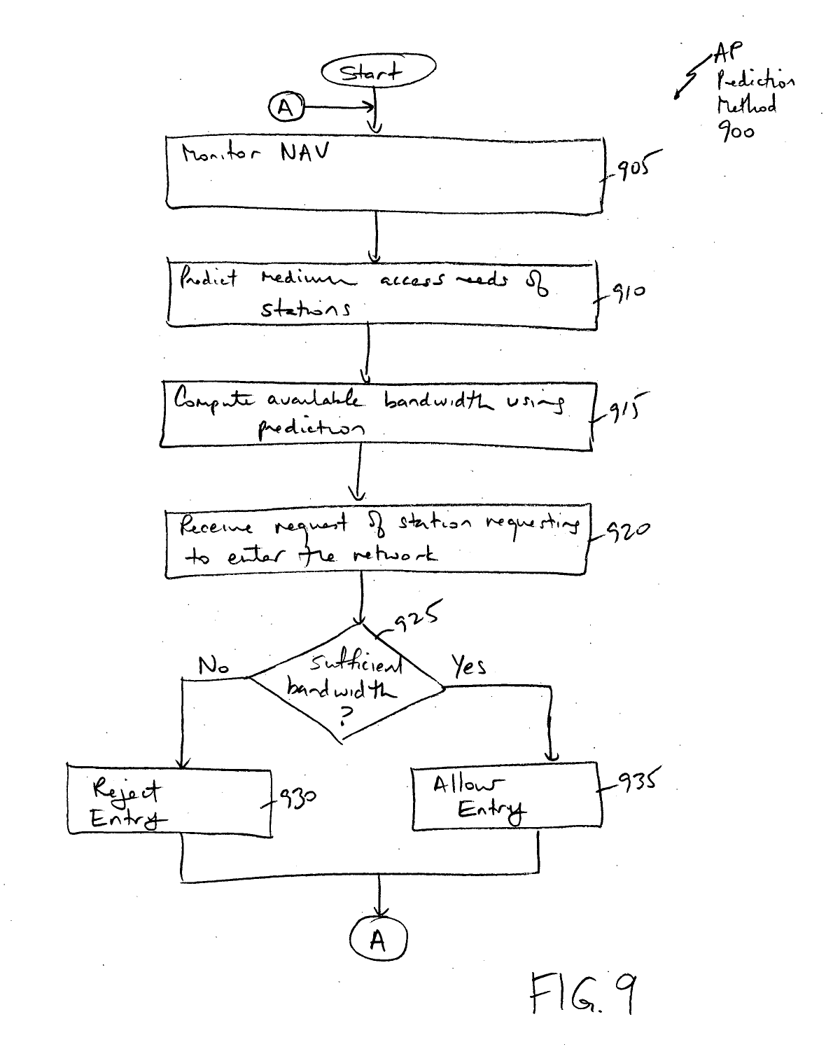

FIG. 9 is a flowchart illustrating a method 900 of predicting and responding to traffic patterns by an access point, in accordance with an embodiment of the present invention. Method 900 begins with the NAV monitor 205 in the access point monitoring the NAV. The traffic prediction module 210 in step 910 predicts the wireless medium access needs of the stations on the network, and in step 915 computes available bandwidth of the wireless network of interest assuming continuing use based on predictions.

The access point in step 920 receives a request of a station requesting access to the wireless network. The response engine 230 in step 925 determines whether the available bandwidth based on predictions is sufficient to allow the requesting station to enter the network. If not, then the response engine 230 in step 930 rejects entry of the requesting station. If so, then the response engine 230 in step 935 allows entry. After either step 930 or 935, method 900 returns to step 905 to resume monitoring the NAV.

In an embodiment, a method in a first station comprises monitoring a network allocation vector in a wireless network; using the network allocation vector to predict patterned access, e.g., periodic access for a given duration, by a second station in the wireless network; and performing a response to the predicted patterned access. Eacmple responses include modifying a MAC layer parameter, e.g., TXOP or a prediction backoff value, in the first station based on the predicted patterned access. Other responses include causing the first station to enter a power-saving mode during times based on the predicted patterned access of the second station, informing a neighboring network to improve roaming, refraining from transmitting during the predicted access times, scheduling transmissions to avoid collisions, informing other applications of the predicted use, selecting another communication method, e.g., a direct link, accepting/rejecting other stations wishing to access the network, etc.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method in a first station comprising:
monitoring a network allocation vector in a wireless network;
using the network allocation vector to predict an access pattern by a second station in the wireless network; and
performing a response based on the predicted access pattern.

2. The method of claim 1, wherein at least one of the first station or the second station includes a client station.

3. The method of claim 1, wherein at least one of the first station or the second station includes an access point.

4. The method of claim 1, wherein the access pattern includes periodic access for a given duration.

5. The method of claim 1, wherein the response includes informing a neighboring network of the predicted access pattern.

6. The method of claim 1, wherein the response includes modifying a MAC layer parameter in the first station.

7. The method of claim 6, wherein the MAC layer parameter includes transmission opportunity TXOP.

8. The method of claim 6, wherein the MAC layer includes a prediction scheduler, and wherein the MAC layer parameter includes a prediction backoff value in the prediction scheduler.

9. The method of claim 1, wherein the response includes causing the first station to enter a power-saving mode during times based on the predicted access pattern of the second station.

10. The method of claim 1, wherein the response includes determining whether to connect the first station into the wireless network.

11. The method of claim 1, wherein the response includes modifying a physical layer parameter.

12. A system in a first station comprising:
a network allocation vector monitor for monitoring a network allocation vector in a wireless network;
a traffic prediction module for using the network allocation vector to predict an access pattern by a second station in the wireless network; and
a response engine for performing a response based on the predicted access pattern.

13. The system of claim 12, wherein at least one of the first station or the second station includes a client station.

14. The system of claim 12, wherein at least one of the first station or the second station includes an access point.

15. The system of claim 12, wherein the access pattern includes periodic access for a given duration.

16. The system of claim 12, wherein the response includes informing a neighboring network of the predicted access pattern.

17. The system of claim 12, wherein the response engine includes a MAC layer parameter adjustment module for modifying a MAC layer parameter in the first station.

18. The system of claim 17, wherein the MAC layer parameter includes transmission opportunity TXOP.

19. The system of claim 17, wherein the MAC layer includes a prediction scheduler, and wherein the MAC layer parameter includes a prediction backoff value in the prediction scheduler.

20. The system of claim 12, wherein the response includes causing the first station to enter a power-saving mode during times based on the predicted access pattern of the second station.

21. The system of claim 12, wherein the response includes determining whether to connect the first station into the wireless network.

22. The system of claim 12, wherein the response includes modifying a physical layer parameter.

23. A system in a first station comprising:
means for monitoring a network allocation vector in a wireless network;
means for using the network allocation vector to predict an access pattern by a second station in the wireless network; and
means for performing a response based on the predicted access pattern.
